(19) United States
(12) Patent Application Publication
(10) Pub. No.: US 2024/0164363 A1
(43) Pub. Date: May 23, 2024

(54) DISPOSABLE INSECT TRAPPING APPARATUS

(71) Applicant: Orbital Gains, Inc., Deer Park, NY (US)

(72) Inventor: John Logalbo, Dix Hills, NY (US)

(21) Appl. No.: 17/980,043

(22) Filed: Nov. 3, 2022

(51) Int. Cl. A01M 1/02; A01M 1/04; A01M 1/14

(52) U.S. Cl. CPC A01M 1/023; A01M 1/04; A01M 1/14

(57) ABSTRACT

An insect trapping apparatus includes a first surface, a second surface, a third surface, and one or more structures. The first surface is coated with an adhesive and an attractant. The attractant includes octenol. The second surface supports a first material. The first material includes a calcium carbonate, a metal carbonate compound, or combinations thereof. The third surface supports a second material. The second material includes a weak acid. The one or more structures are configured to be manipulated to cause the first and second materials to react with one another within the insect trapping apparatus and emit carbon dioxide from the insect trapping apparatus after the first and second materials react with one another.

### FIELD

This disclosure is directed to insect trapping apparatus, and more particularly, to disposable insect trapping apparatus.

### BACKGROUND

Insects, even though there have been many technical advances in preventive entomology, still present a fundamental problem both hygienically and economically. Insects attack food-producing plants and their produce, transport disease-producing organisms, cause pain and discomfort by bites and stings, and are nuisances in countless other ways. Various methods have been devised to control insects but have not always been found to be satisfactory for several applications. Most chemical insecticides are toxic and hazardous to birds, fish, animals, and even humans in relatively small amounts. Even extremely minute amounts are hazardous to some species. The damage caused to the environment by chemical insecticides is sometimes greater than the total benefit obtained through their use. Thus, the search has continued for economical, effective, convenient, and non-hazardous methods to control insects.

### SUMMARY

One aspect of the disclosure is directed to an insect trapping apparatus. The insect trapping apparatus includes a first surface, a second surface, a third surface, and at least one structure. The first surface is coated with an adhesive and an attractant. The attractant includes octenol. The second surface supports a first material. The first material includes a calcium carbonate, a metal carbonate compound, or combinations thereof. The third surface supports a second material. The second material includes a weak acid. The at least one structure is configured to be manipulated to cause the first and second materials to react with one another within the insect trapping apparatus and emit carbon dioxide from the insect trapping apparatus after the first and second materials react with one another.

In aspects, the first surface may be an outer surface of a tube assembly. The outer surface may include a removable cover that is configured to peel-away from the outer surface. The tube assembly may define a central cavity supporting a divider that separates the central cavity between an upper segment that supports the first material and a lower segment that supports the second material. The tube assembly may define a plurality of openings in the upper segment configured to enable the carbon dioxide to emit from the central cavity into ambient air surrounding the tube assembly.

In aspects, the at least one structure may include a rigid rod having a sharpened tip. The rigid rod may be coupled to the tube assembly and selectively movable relative to the tube assembly to cause the sharpened tip to pierce the divider and enable the first and second materials to react with one another. The rigid rod may include a detent structure configured to couple to the tube assembly to enable the sharpened tip to be suspended above the divider.

In aspects, the at least one structure may include a syringe assembly that is selectively receivable within the tube assembly, the syringe assembly including the second and third surfaces. The second surface may be a divider that separates the first and second materials within the syringe assembly. The syringe assembly may include a plunger assembly having a sharpened tip configured to pierce the divider to enable the first and second materials to react with one another for causing carbon dioxide to release from the syringe assembly. The syringe assembly may include a support plate that secures the syringe assembly to a center ring supported within the tube assembly. The support plate may define a plurality of apertures to enable the carbon dioxide to release from an upper portion of the syringe assembly.

In aspects, the at least one structure may include a first elongated body member supporting the second surface and a second elongated body member supporting the second surface. The second surface may include first adhesive strips, and the third surface may include second adhesive strips. The first and second adhesive strips may be configured to secure to one another to secure the first and second elongated body members together. The first and second elongated body members may be independent of one another. The first and second elongated body members may be coupled together by a hinge that enables the first and second elongated body members to fold together to cause the first and second materials to react with one another for releasing carbon dioxide through slots defined between the first and second elongated body members.

In aspects, the insect trapping apparatus may include a first tube member, and the at least one structure may include a second tube member. The first and second tube members may be selectively receivable within the tube assembly.

In aspects, the tube assembly may include a tubular member. The tubular member may include the outer surface formed of a material that is clear. The insect trapping apparatus may further include a first tube member. The first tube member may be a glow stick that emits light through the clear material of the tubular member. The at least one structure may include a second tube member including the second and third surfaces. The second tube member may support the first and second materials and may be receivable with the first tube member in the tubular member. The second tube member may be flexible to cause the first and second materials to react for emitting the carbon dioxide from the second tube member when the second tube member is disposed within the tubular member.

In aspects, the outer surface may include optical brighteners that intensify the light from the glow stick to provide a visual attractant to insects while the octenol on the outer surface of the tubular member and the carbon dioxide emitted from the reaction of the first and second materials provide olfactory attractants to the insects, wherein each of the attractants are configured to lure and trap the insects on the adhesive on the outer surface of the tubular member.

According to another aspect of this disclosure, an insect trapping apparatus includes a tube assembly and a tubular structure. The tube assembly has an outer surface supporting an adhesive including an octenol embedded therein. The tubular structure supports a first material and a second material therein. The first and second materials are separated, wherein upon an application of sufficient force to the tubular structure, the first and second materials react with one another to emit carbon dioxide from the tubular structure, wherein the first material includes a calcium carbonate, a metal carbonate compound, or combinations thereof, and the second material includes a weak acid.

According to still another aspect of this disclosure, an insect trapping apparatus includes a first elongated body member and a second elongated body member. The first elongated body member has an inner surface supporting a first material and an outer surface supporting an adhesive and octenol. The first material includes a calcium carbonate, a metal carbonate compound, or combinations thereof. The second elongated body member has an inner surface supporting a second material and an outer surface supporting an adhesive and octenol. The second material includes a weak acid. The first and second elongated bodies include adhesive strips on the respective inner surfaces of the first and second elongated bodies. The first and second materials are configured to react with one another to emit carbon dioxide from between the first and second elongated body members when the adhesive strips of the first and second elongated bodies are bonded together.

Other features of the disclosure will be appreciated from the following description.

### BRIEF DESCRIPTION OF THE DRAWINGS

Various aspects of the disclosed insect trapping apparatus are described herein below with reference to the drawings, wherein:

FIG. 1 is a perspective view of a disposable insect trapping apparatus shown mounted on a hanging structure in accordance with principles of this disclosure;

FIG. 2 is a perspective view of the disposable insect trapping apparatus of FIG. 1 shown with a cover sheet of the disposable insect trapping apparatus removed;

FIG. 3 is a cross-sectional view of FIG. 2 as taken along section line 3-3 shown in FIG. 2 with a piercing assembly of the disposable insect trapping apparatus shown in a first position;

FIG. 4 is another cross-sectional view of the disposable insect trapping apparatus of FIG. 3 illustrating the piercing assembly in a second position;

FIG. 5 is a perspective view illustrating a plurality of insects trapped on the disposable insect trapping apparatus when the piercing assembly is disposed in the second position as shown in FIG. 4;

FIG. 6 is a perspective view of another disposable insect trapping apparatus in accordance with the principles of this disclosure, the disposable insect trapping apparatus including a syringe assembly and a tube assembly, the syringe assembly shown separated from the tube assembly;

FIG. 7 is a perspective view of the disposable insect trapping apparatus of FIG. 6 with the syringe assembly coupled to the tube assembly, the tube assembly shown with a cover sheet of the tube assembly removed;

FIG. 8 is a cross-sectional view of FIG. 7 as taken along section line 8-8 shown in FIG. 7 with the syringe assembly shown in a first position;

FIG. 9 is another cross-sectional view of the disposable insect trapping apparatus of FIG. 7 with the syringe assembly shown in a second position;

FIG. 10 is a perspective view illustrating a plurality of insects shown trapped on the disposable insect trapping apparatus when the syringe assembly is disposed in the second position as shown in FIG. 9;

FIGS. 11-14 are views of inner and outer sides of a pair of elongated body members of still another disposable insect trapping apparatus in accordance with the principles of this disclosure, the pair of elongated body members shown with cover sheets of the disposable insect trapping apparatus removed for clarity;

FIGS. 15 and 16 are progressive views illustrating the cover sheets of the pair of elongated body members being removed and the pair of elongated body members being coupled together;

FIG. 17 is a perspective view showing the pair of elongated body members coupled together with the cover sheets of the pair of elongated body members removed, the pair of elongated body members having insects shown trapped on outer sides of the pair of elongated body members;

FIG. 18 is a top view of an inner side surface of yet another disposable insect trapping apparatus with a cover sheet of the inner side surface of the disposable insect trapping apparatus removed for clarity, the disposable insect trapping apparatus shown in an unfolded state;

FIG. 19 is a top view of an outer side surface of the disposable insect trapping apparatus of FIG. 18 with a cover sheet of the outer side surface of the disposable insect trapping apparatus removed for clarity, the disposable insect trapping apparatus shown in an unfolded state;

FIG. 20 is a perspective view of the disposable insect trapping apparatus of FIG. 18 with the cover sheets supported on the inner and outer side surfaces of the disposable insect trapping apparatus, the disposable insect trapping apparatus shown in an unfolded state;

FIG. 21 is a perspective view of the disposable insect trapping apparatus of FIG. 18 with the cover sheets removed and the disposable insect trapping apparatus disposed in a folded state, the disposable insect trapping apparatus shown with a plurality of insects trapped on the outer side surface of the disposable insect trapping apparatus;

FIG. 22 is a perspective view, with parts separated, of another disposable insect trapping apparatus;

FIGS. 23 and 24 are cross-sectional views as taken along section lines 23-23 and 24-24 shown in FIG. 22; and

FIG. 25 is a perspective view of the disposable insect trapping apparatus of FIG. 22 with a cover sheet of the disposable insect trapping apparatus removed, the disposable insect trapping apparatus shown with a plurality of insects trapped on the disposable insect trapping apparatus.

### DETAILED DESCRIPTION

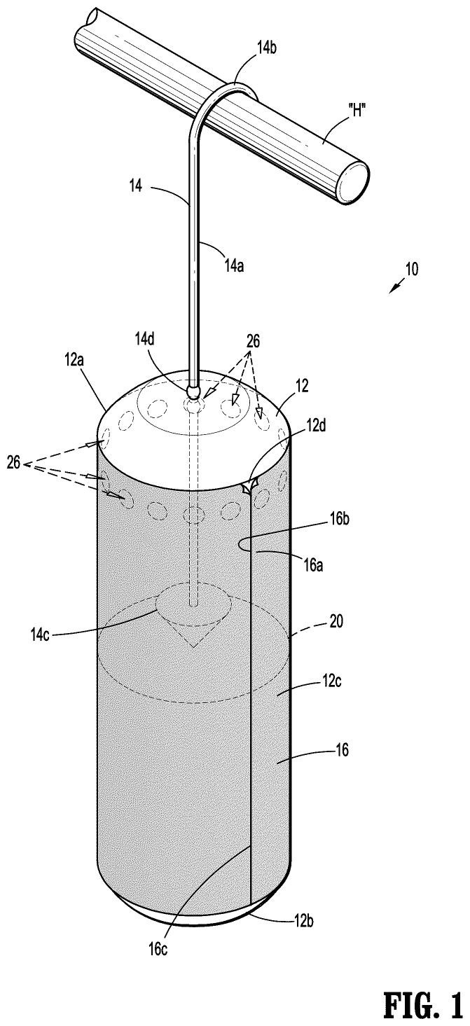

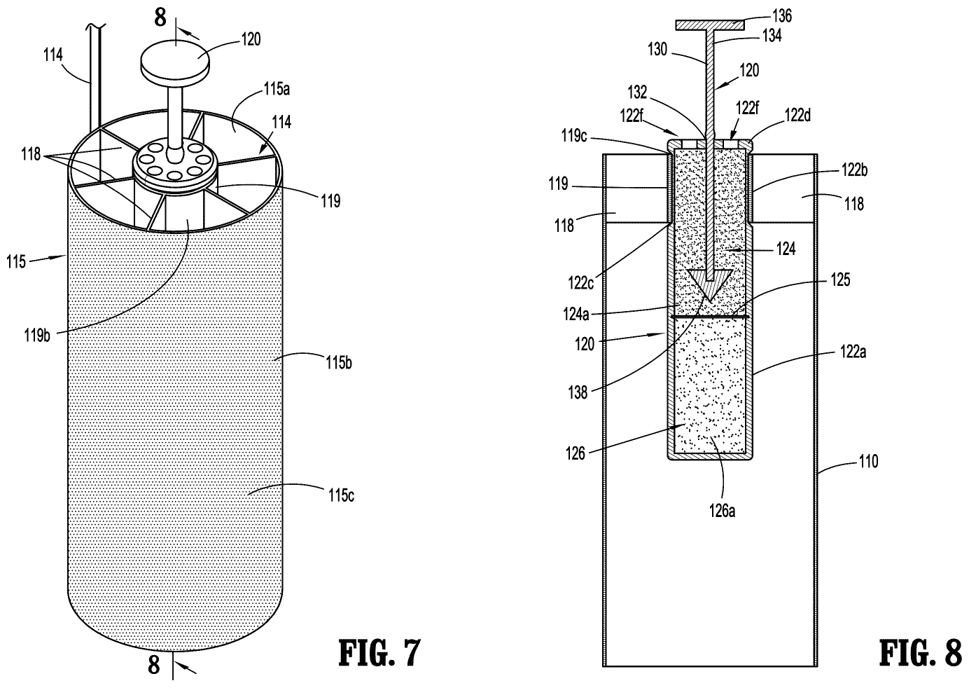

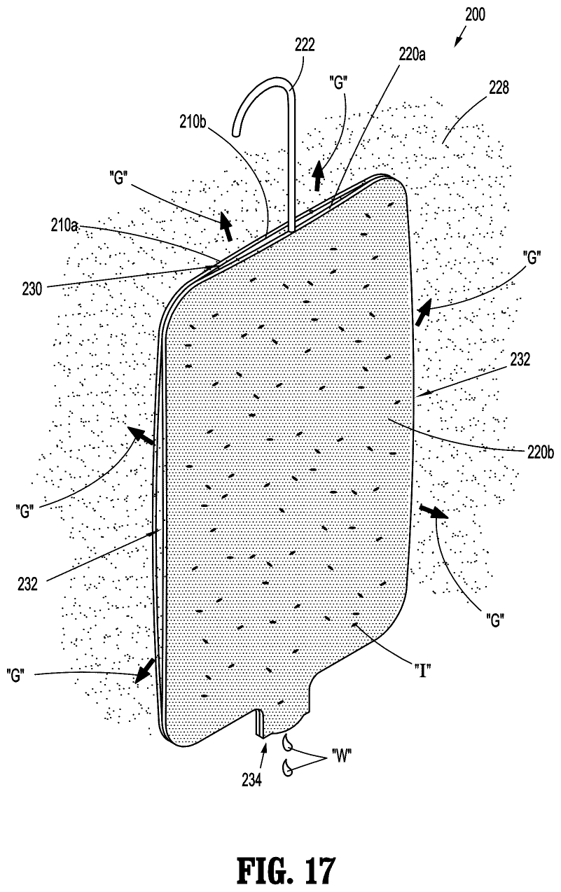

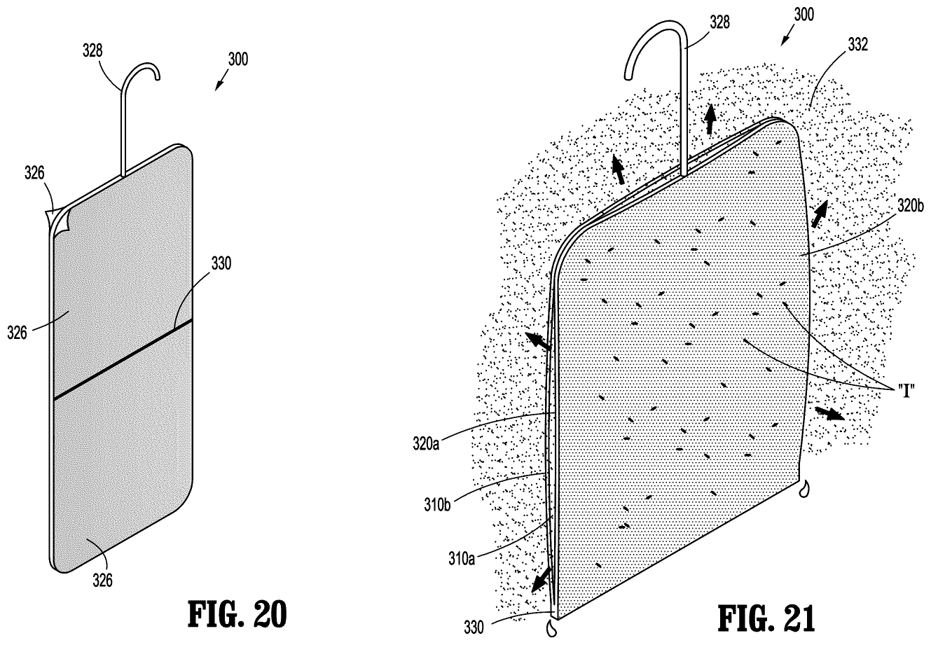

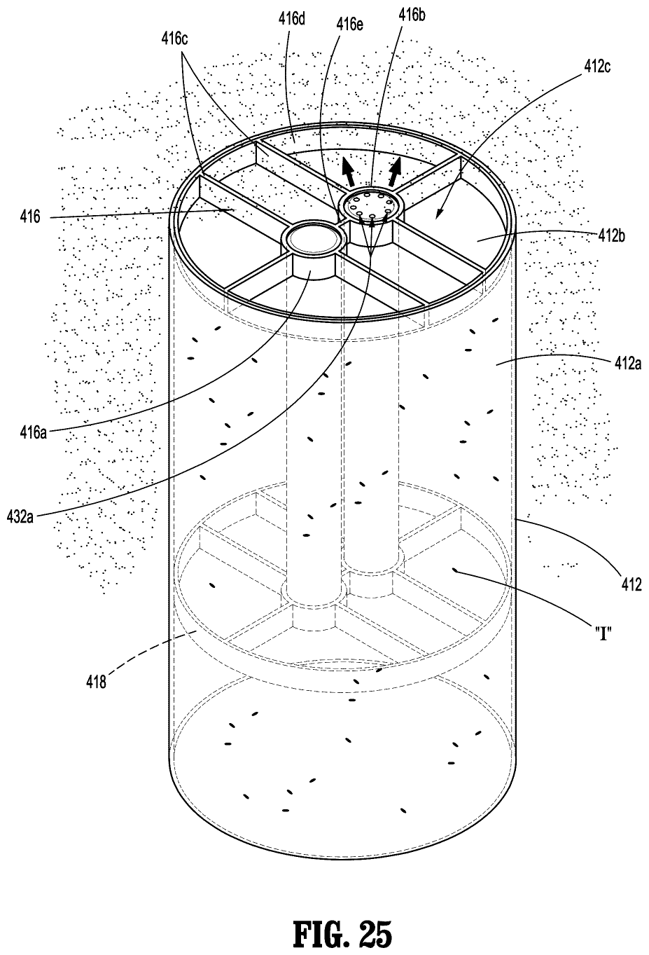

The disclosed insect trapping apparatus will now be described in detail with reference to the drawings, namely FIGS. 1-25, in which like reference numerals designate identical or corresponding elements in each of the several views. However, it is to be understood that aspects of the disclosure are merely exemplary of the disclosure and may be embodied in various forms. Well-known functions or constructions are not described in detail to avoid obscuring the disclosure in unnecessary detail. Therefore, specific structural and functional details disclosed herein are not to be interpreted as limiting, but merely as a basis for the claims and as a representative basis for teaching one skilled in the art to variously employ the disclosure in virtually any appropriately detailed structure. In addition, directional terms such as upper, lower, and similar terms are used to assist in understanding the description and are not intended to limit the disclosure.

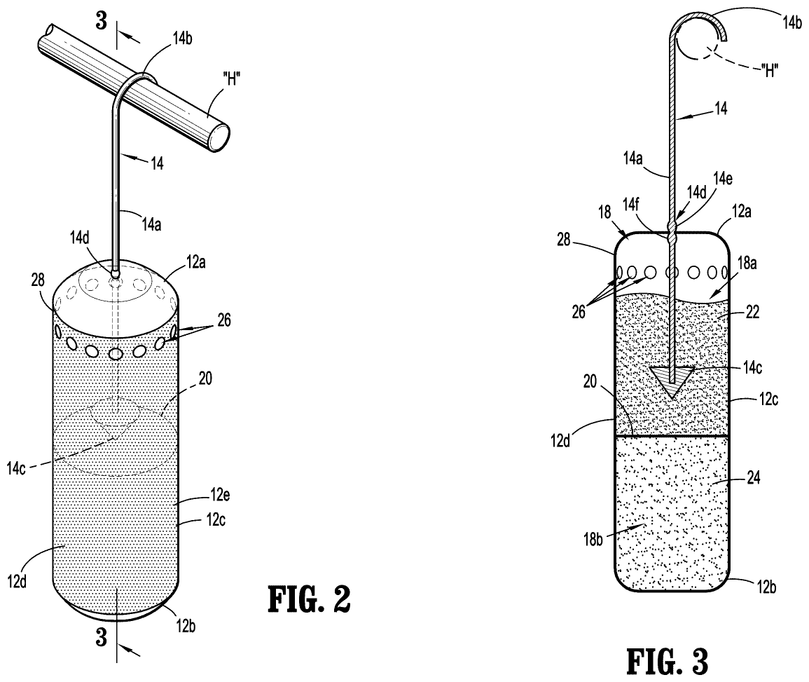

As seen in FIGS. 1 and 2, a disposable insect trapping apparatus 10 includes a tube assembly 12 and a hanger assembly 14 secured to the tube assembly 12 for securing insect trapping apparatus 10 to a hanging structure “H” such as a tree branch or mounted rod. Tube assembly 12 has an upper end portion 12a, a lower end portion 12b, and an intermediate portion 12c supported between the upper and lower end portions 12a, 12b. Intermediate portion 12c supports a cover or seal 16, which may be in form of wax paper and is selectively removable (e.g., via peel-away technique) from intermediate portion 12c. Cover 16 has a first end portion 16a and a second end portion 16b. Cover 16 is wrapped around intermediate portion 12c of tube assembly 12 such that first and second end portions 16a meet one another in opposing relationship to define a seam 16c that extends lengthwise down intermediate portion 12c to facilitate removal of cover 16 from intermediate portion 12 of tube assembly 12. Intermediate portion 12c includes an outer surface 12d coated with an adhesive 12e including an attractant (e.g., Matsutake Alcohol: 1-octen-3-ol), optical brightener (e.g., UV (ultraviolet) brightener), and/or a fluorescent dye (visual attraction for insects) disposed thereon an/or embedded therein. Adhesive 12e maintains cover 16 secured to outer surface 12d of tube assembly 12 and functions to trap insects on outer surface 12d when cover 16 is removed from outer surface 12d for exposing adhesive 12e.

With reference also to FIG. 3, tube assembly 12 of insect trapping apparatus 10 defines a central cavity 18 supporting a divider 20 that separates central cavity 18 between an upper segment 18a that supports a first material 22, such as calcium carbonate, metal carbonate compounds, etc., or combinations thereof, and a lower segment 18b that supports a second material 24, such as a weak acid solution, aqueous, and/or gel, and which may include an agar solution and/or water-based gallants. Moreover, the weak acid can be any suitable weak acid such as hydrochloric acid, acetic acid, and/or acidic fruit (e.g., apple cider, lemons, limes, plums, grapes, grapefruit, blueberries, pineapples, oranges, peaches, and/or tomatoes).

Tube assembly 12 of insect trapping apparatus 10 further defines a plurality of spaced-apart openings 26 extending about a circumference of an upper portion 28 of tube assembly 12. Each opening 26 extends through tube assembly 12 to expose central cavity 18 to ambient air external of insect trapping apparatus 10. Openings 26 are supported above first material 22 to prevent first material 22 from escaping through openings 26.

With continued reference to FIGS. 1-3, hanger assembly 14 of insect trapping apparatus 10 includes a rigid rod 14a having a hook 14b on an upper end of rigid rod 14a and a sharpened tip 14c supported on a lower end of rigid rod 14a. Rigid rod 14a further includes a detent structure 14d supported on an intermediate portion of rigid rod 14a. Detent structure 14d may include an upper ball member 14e and a lower ball member 14f that define a support recess 14g between the upper and lower ball members 14e, 14f for securing hanger assembly 14 to upper end portion 12a of tubular member 12 with sharpened tip 14c suspended above divider 20 as shown in FIG. 3.

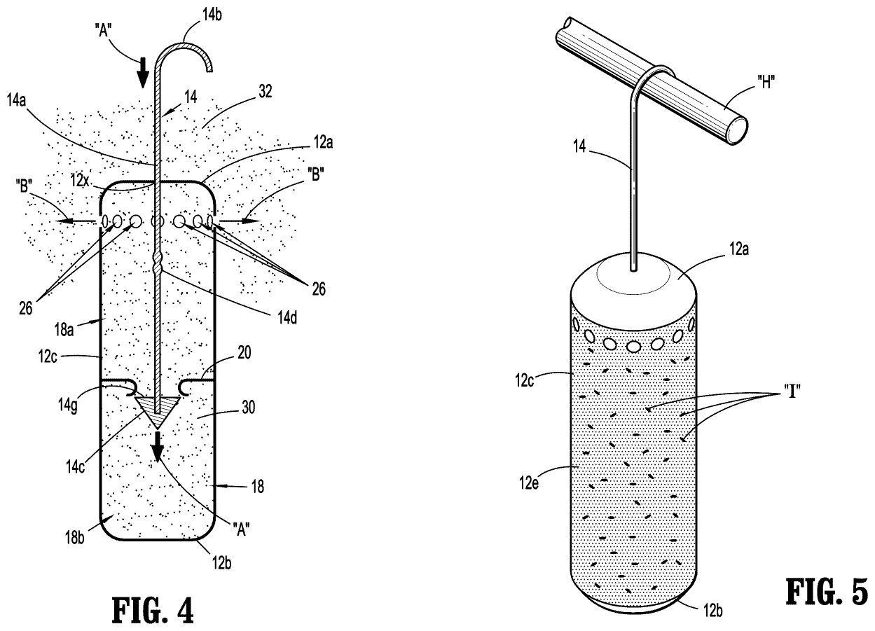

In use, as shown in FIGS. 4 and 5, hanger assembly 14 is advanced downwardly into central cavity 18, as indicated by arrows “A,” with sufficient force to overcome frictional forces detent structure 14d provides to retain hanger assembly 14 in position on upper end portion 12a so that detent structure 14d is separated from upper end portion 12a of tube assembly 12. Once advanced sufficiently far downward relative to tube assembly 12, sharpened tip 14c pierces through divider 20 from upper segment 18a of central cavity 18 into lower segment of central cavity 18. With divider 20 pierced, upper and lower segments 18a, 18b become disposed in fluid communication with one another whereby central cavity 18 becomes unitary and the first and second materials 22, 24 intermix and react with one another through gravity and/or osmotic forces. The reaction may be exothermic (or not), creating carbon dioxide gas and water. For example, when the first material 22 is calcium carbonate and the second material 24 is a weak acid gel, the calcium carbonate and the weak acid gel intermix and react to cause carbon dioxide and/or heat 32 to release into the ambient air, as indicated by arrows “B,” with the attractant (e.g., Matsutake Alcohol 1% (1-octen-3-ol) in 99% Propylene Glycol (PG)) and/or visual emissions from optical brighteners and/or fluorescent dyes projecting around insect trapping apparatus 10 to help attract insects “I” to insect trapping apparatus 10 so that insects “I” are lured and trapped on adhesive 12e.

Furthermore, upon piercing divider 20, and with detent structure 14d separated from upper end portion 12a, tube assembly 12 and hangar assembly 14 can be drawn in opposite directions such that an inner surface of upper end portion 12a of tube assembly 12 can be supported on either detent structure 14d or an upper end face 14g of sharpened tip 14c, depending on a size of a hole 12x (FIG. 4) defined in the upper end portion 12a upon initially separating detent structure 14 from upper end portion 12a, when insect trapping apparatus 10 is hung on hanging structure “H.”

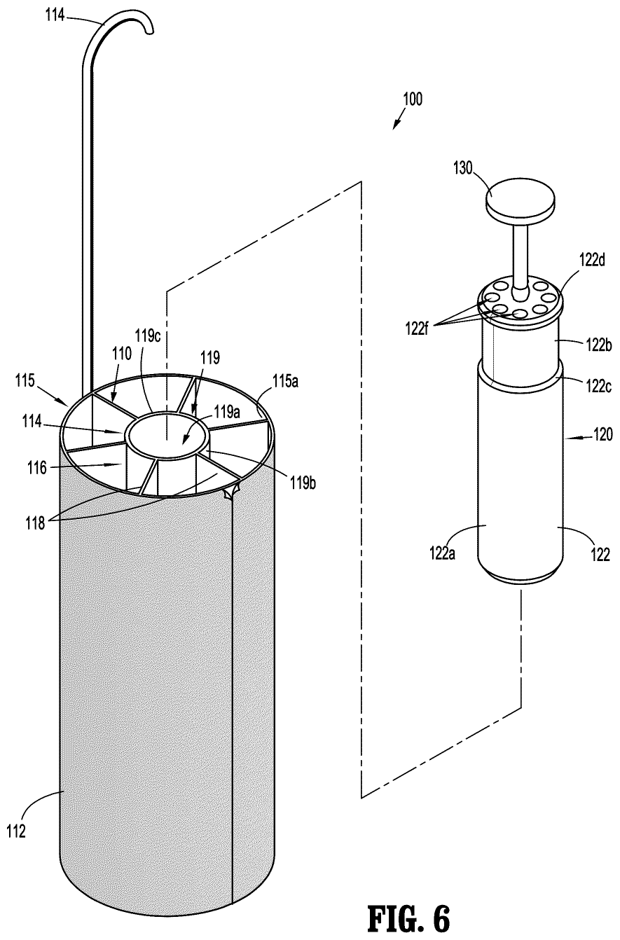

Turning now to FIGS. 6-10, another disposable insect trapping apparatus is like disposable insect trapping apparatus 10 and is referred to as 100. Disposable insect trapping apparatus 100 includes a tube assembly 110 and a syringe assembly 120 that is securable to tube assembly 110. Tube assembly 110 includes a removable cover 112 and a hanger 114 extending from an upper end portion of tube assembly 110 to enable disposable insect trapping apparatus 100 to be hung from hanging structure “H.” Tube assembly 110 further includes a mounting assembly 114 disposed within a cavity 116 defined by an inner surface 115a of an outer tube 115 of tube assembly 110. Mounting assembly 114 includes a plurality of spaced-apart support arms 118 and a center ring 119 extending radially outward from an outer surface 119b of center ring 119 to the inner surface 115a of outer tube 115. Center ring 119 defines a center passage 119a configured to receive syringe assembly 120 for enabling mounting assembly 114 to support syringe assembly 120 within an upper portion of cavity 116 of tube assembly 110 and on an upper end face 119c of center ring 119. Outer tube 115 includes an outer surface 115b that is coated with an adhesive 115c including an attractant, which may be in the form of a fluorescent dye.

Syringe assembly 120 of insect trapping apparatus 100 includes a syringe body 122 having a lower portion 122a with a first diameter and an upper portion 122b with a second diameter that is smaller than the first diameter so that a ledge 122c separates the lower and upper portions 122a, 122b. Syringe body 122 further includes a support plate 122d disposed on top of upper portion 122b and extending radially farther outward than upper portion 122d to enable syringe assembly 120 to rest on the upper end face 119c of center ring 119. In this position, upper portion 122b of syringe body 122 is captured within center passage 119a of center ring 119 and lower portion 122a of syringe body 122 is disposed beneath center ring 119 within cavity 116 of tube assembly 110. Support plate 122d defines a plurality of apertures 122f therethrough. Syringe body 122 further defines an upper cavity 124 and a lower cavity 126 that are separated by a divider 125. Upper cavity 124 supports a first material 124a such as calcium carbonate and lower cavity 126 supports a second material 126a such as a weak acid.

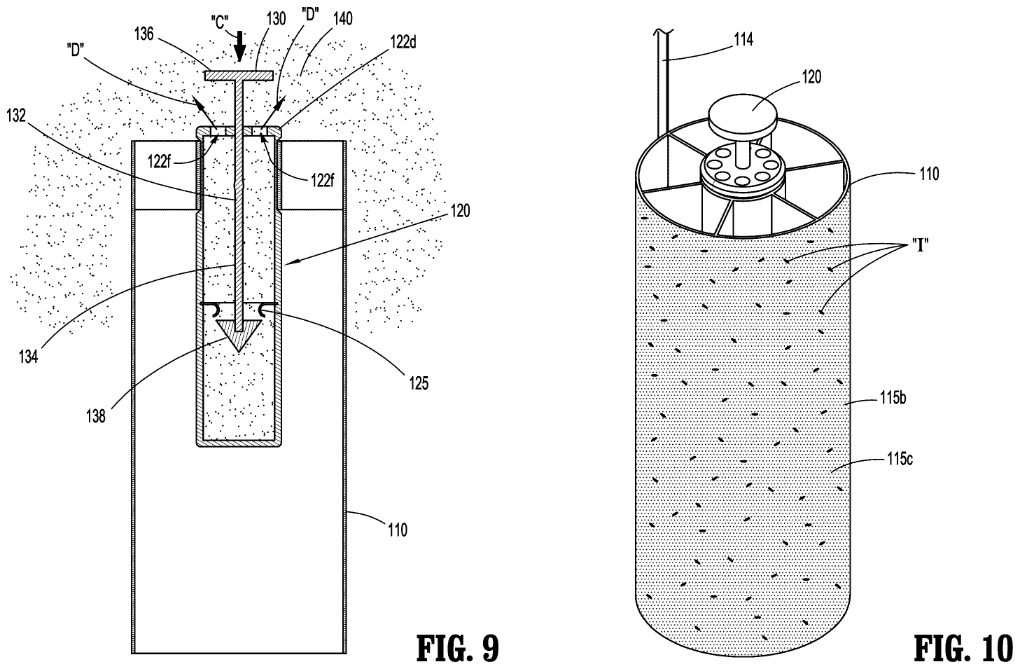

Syringe assembly 120 further includes a plunger assembly 130 secured to support plate 122d by a detent structure 132 on a rigid rod 134 of plunger assembly 130. Plunger assembly 130 includes an actuator pad 136 on an upper end of rigid rod 134 and a sharpened tip 138 on a lower end of rigid rod 134 for selectively piercing divider 125 upon depressing actuator pad 136, as indicted by arrow “C”. Like that described above with respect to insect trapping apparatus 10, once divider 125 is pierced as shown in FIG. 9, the first and second materials 124a, 126a intermix and react to release carbon dioxide and/or heat 140 through apertures 122f of support plate 122d, as indicated by arrows “D” (FIG. 9) to attract insects “I” to adhesive 115c on tube assembly 110 (FIG. 10). As can be appreciated, the attractant (e.g., Matsutake Alcohol: 1-octen-3-ol) and/or visual emissions from UV brighteners and/or fluorescent dyes on the insect trapping apparatus 100 also help to attract the insects “I.”

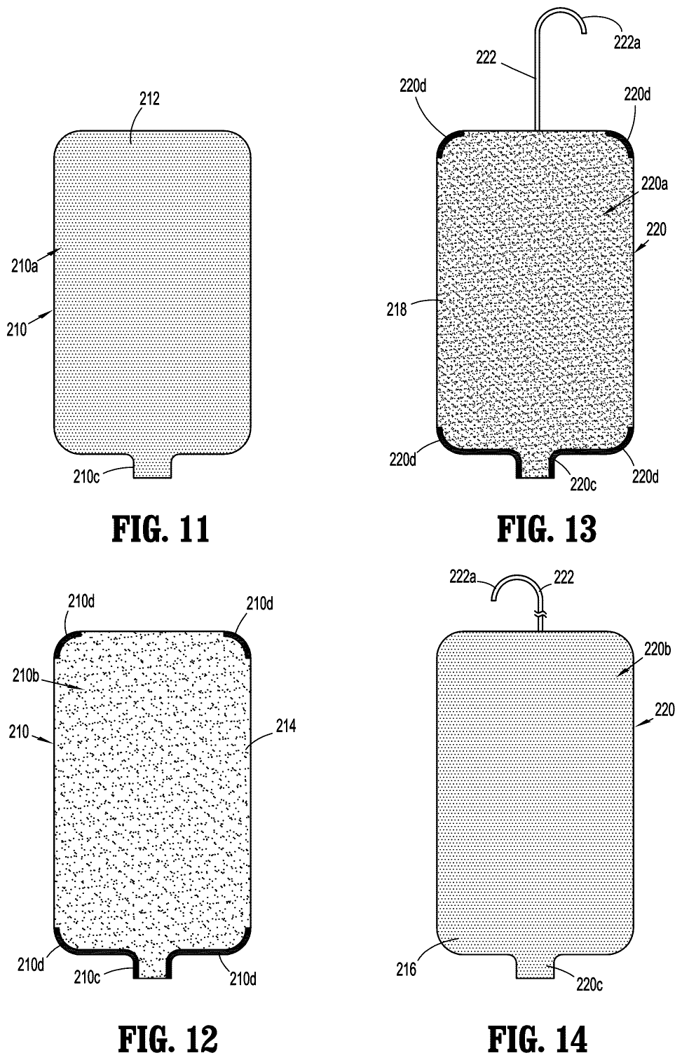

Referring now to FIGS. 11-17, still another disposable insect trapping apparatus is referred to as 200 and includes a first elongated body member 210 and a second elongated body member 220 that are securable to one another, and which may be sealed in separate packaging such as foil packets (not shown) before use/securement to one another.

First elongated body member 210 of insect trapping apparatus 200 includes an outer side surface 210a and an inner side surface 210b. First elongated body member 210 is shown with a rectangular configuration but may be any suitable circular and/or non-circular (e.g., polygonal) shape. First elongated body member 210 further includes a tab 210c extending from a lower end portion of first elongated body member 210. Outer side surface 210a of first elongated body member 210 has an adhesive 212 coated thereon which can include attractant, UV brighteners, and/or fluorescent dyes disposed thereon and/or embedded therein. Inner side surface 210b of first elongated body member 210 has a first material 214 coated thereon which may include a weak acid solution, aqueous, gel, etc., or combinations thereof. Edges of inner side surface 210b of first elongated body member 210, for example, corner edges, further include adhesive strips 210d.

Second elongated body member 220 of insect trapping apparatus 200 includes an inner side surface 220a and an outer side surface 220b. Second elongated body member 220 is shown with a rectangular configuration but may be any suitable circular and/or non-circular shape. Second elongated body member 220 further includes a tab 220c extending from a lower end portion of second elongated body member 220. Outer side surface 220b of second elongated body member 220 has an adhesive 216 coated thereon which can include attractant, optical brighteners, and/or fluorescent dyes disposed thereon and/or embedded therein. Inner side surface 220a of second elongated body member 220 has a second material 218 coated thereon which may include calcium carbonate, metal carbonate compounds, etc., or combinations thereof. Second elongated body member 220 further includes adhesive strips 220d disposed along edges of inner side surface 220a of second elongated body member 220 which correspond to adhesive strips 210d along edges of inner side surface 210b of first elongated body member 210. Second elongated body member 220 also includes a hook member 222 having a hook 222a extending from an upper end portion of second elongated body member 220 for facilitating hanging of disposable insect trapping apparatus 200. Hook member 222 may be supported within second elongated body member 220 between inner and outer side surfaces 220a, 220b and/or on one or both of inner and/or outer side surfaces 220a, 220b of second elongated body member 220.

In aspects, in addition to and/or alternatively to hook member 222, first and/or second elongated body members 210, 220 may have a lattice structure, one or more holes, etc. to facilitate hanging of the insect trapping apparatus.

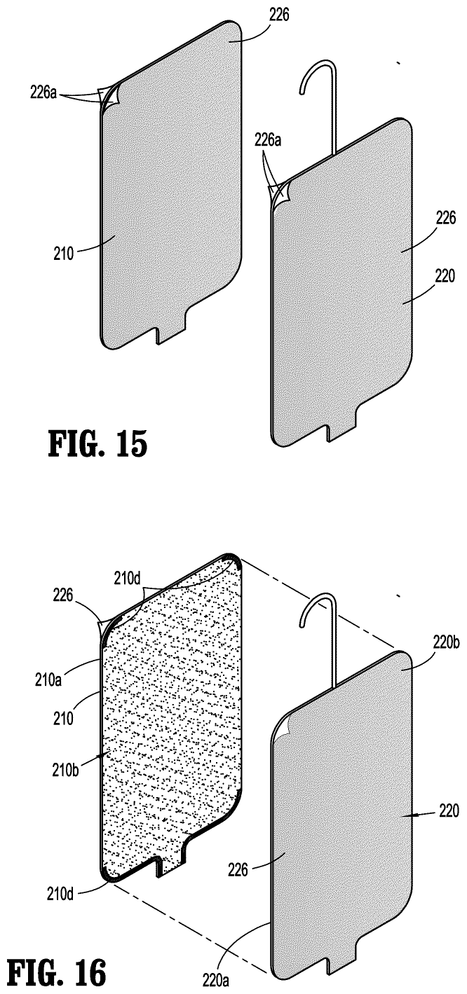

As seen in FIGS. 15 and 16, the inner and outer side surfaces of first and second elongated body members 210, 220 may include covers or seals 226 (e.g., wax paper), which may be removable by, for example, a peel-away technique. Covers 226 may include extension portions 226a to facilitate removal. Indeed, to use insect trapping apparatus 200, after removing first and second elongated body members 210, 220 from their respective sealed foil packages (not shown), covers 226 are removed and first and second elongated body members 210, 220 are secured to one another via adhesive strips 210d, 220d of respective first and second elongated body members 210, 220 that bond together upon an application of pressure to adhesive strips 210d, 220d. When first and second elongated body members 210, 220 are coupled together insect trapping apparatus 200 defines release slots 230, 232 through upper and side surfaces of insect trapping apparatus 200 and a weep hole 234 via tabs 210c, 220c of first and second elongated body members 210, 220. In this position, the first and second materials 214, 218 of respective first and second elongated body members 210, 220 intermix and react to release carbon dioxide and/or heat 228 through release slots 230, 232 as illustrated by arrows “G” to attract insects “I” for trapping insects “I” to adhesives 212, 216 on outer side surfaces 210a, 220b of first and second elongated body members 210, 220. Any water “W” generated will exit through weep hole 234 at the bottom of insect trapping apparatus 200. Again, any attractant (e.g., Matsutake Alcohol: 1-octen-3-ol) and/or visual emissions from optical brighteners and/or fluorescent dyes on the insect trapping apparatus 200 also help to attract the insects “I.”

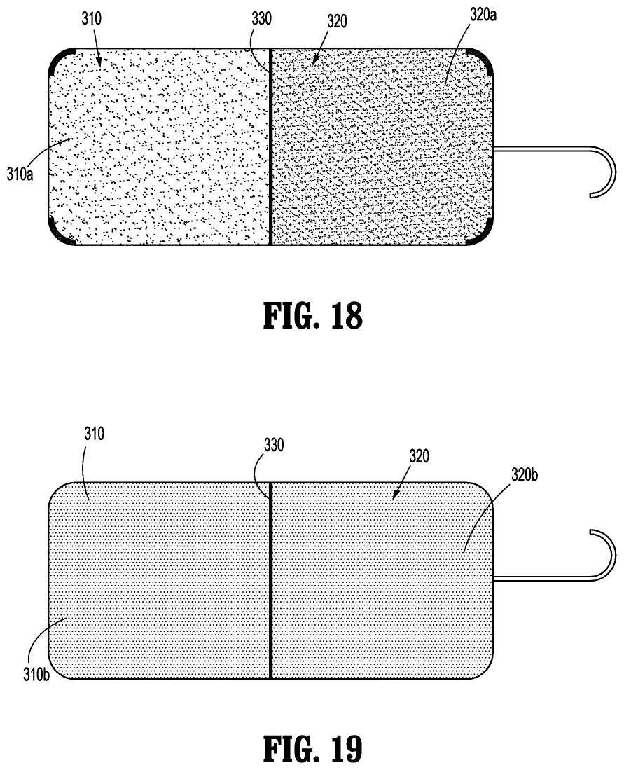

With reference to FIGS. 18-21, still another insect trapping apparatus 300 is like insect trapping apparatus 200, but instead of two separate and independent elongated body members, insect trapping apparatus 300 includes first and second elongated body members 310, 320 that are coupled together via a hinge 330. Indeed, first elongated body member 310 has an inner side surface 310a and an outer side surface 310b, and second elongated body member 320 has an inner side surface 320a and an outer side surface 320b. And like insect trapping apparatus 200, once covers or seals 326 (e.g., wax paper) are removed, the inner side surfaces 310a, 320a are configured to engage one another when folded to together via hinge 330 to emit carbon dioxide 332 and attractant so that insects “I” will be trapped on the adhesive on outer side surfaces 310b, 320b of the first and second elongated body members 310, 320. Further, insect trapping apparatus 300 can be hung via hook member 328.

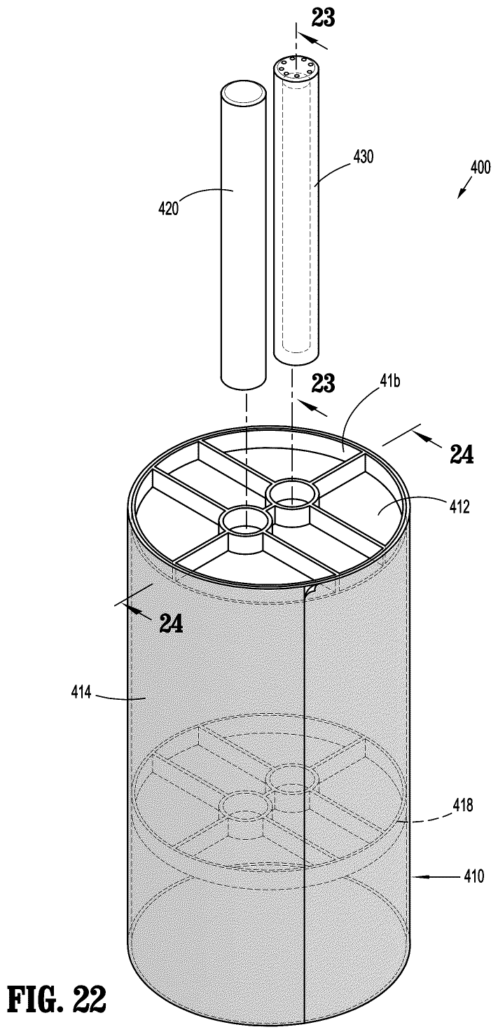

Turning now to FIGS. 22-25, another insect trapping apparatus is referred to as 400. Insect trapping apparatus 400 includes a tube assembly 410, a first tube member 420, and a second tube member 430. First and second tube members 420, 430 are receivable within tube assembly 410 and are flexible.

Tube assembly 410 includes a tubular body 412 that supports a cover 414 (e.g., wax paper) which is selectively removable (e.g., via peel-away technique) from tubular body 412. Tubular body 412 can include a clear material such as transparent and/or translucent material. Tubular body 412 includes an outer surface 412a and an inner surface 412b. Outer surface 412a is coated with a clear adhesive 412c including an attractant, optical brighteners, and/or a fluorescent dye disposed thereon an/or embedded therein. Tube assembly 410 further includes an upper mounting assembly 416 and a lower mounting assembly 418 that are positioned axially offset from one another (and vertically-aligned with one another). Upper mounting assembly 416 is disposed at an upper end portion of tubular body 412 and lower mounting assembly 418 is disposed at a lower end portion of tubular body 412. And upper mounting assembly 416 can be disposed at an upper end of tubular body 412 while lower mounting assembly 418 can be disposed offset from a lower end of tubular body 412.

Upper mounting assembly 416 of tube assembly 410 includes a first tube ring 416a, having open upper and lower ends for receiving first tube member 420 therethrough and a second tube ring 416b having open upper and lower ends for receiving second tube member 430 therethrough. First and second tube rings 416a, 416b are disposed adjacent to one another in a central portion of a lumen 412c defined through tubular body 412 First and second tube rings 416a, 416b are supported in lumen 412c by a plurality of support arms 416c extending radially outward from first and second tube rings 416a, 416b to a mounting ring 416d secured to inner surface 412b of tubular body 412, and a connector arm 416e extending between first and second tube rings 416a, 416b.

Lower mounting assembly 418 of tube assembly 410 is substantially similar to upper mounting assembly 416, but instead of having first and second tube rings with open upper and lower ends, lower mounting assembly 418 includes first and second tube rings 418a, 418b having support platforms 418c (FIG. 24) extending along lower ends of respective first and second tube rings 418a, 418b to support first and second tube members 420, 430 within the first and second tube rings 416a, 416b, 418a, 418b of upper and lower mounting assemblies 416, 418 so that the first and second tube members 420, 430 can be vertically-oriented within tubular body 412.

First tube member 420 of insect trapping apparatus 400 may be in the form of a glow stick that is flexible to cause the glow stick to “light up.” For example, first tube member 420 can include an outer plastic tube that holds a solution of oxalate esters and an electron-rich dye, and a glass vial filled with a hydrogen peroxide solution. Sufficient flexing of first tube member 420 breaks the glass vial causing the hydrogen peroxide to react with the oxalate esters to form a high-energy intermediate such as 1,2-dioxetanedione, which reacts with the electron-rich dye, which may be of any suitable color. In particular, the intermediate snags an electron from the dye and then breaks down into carbon dioxide and a negatively charged carbon dioxide radical anion. The dye, which has become a positively charged radical cation, then takes back an electron from the carbon dioxide radical anion. In taking back the electron, the dye gains excess energy. The molecule uses that energy to move into an excited state before dropping back down and emitting the energy as a photon of light (e.g., the “glow”).

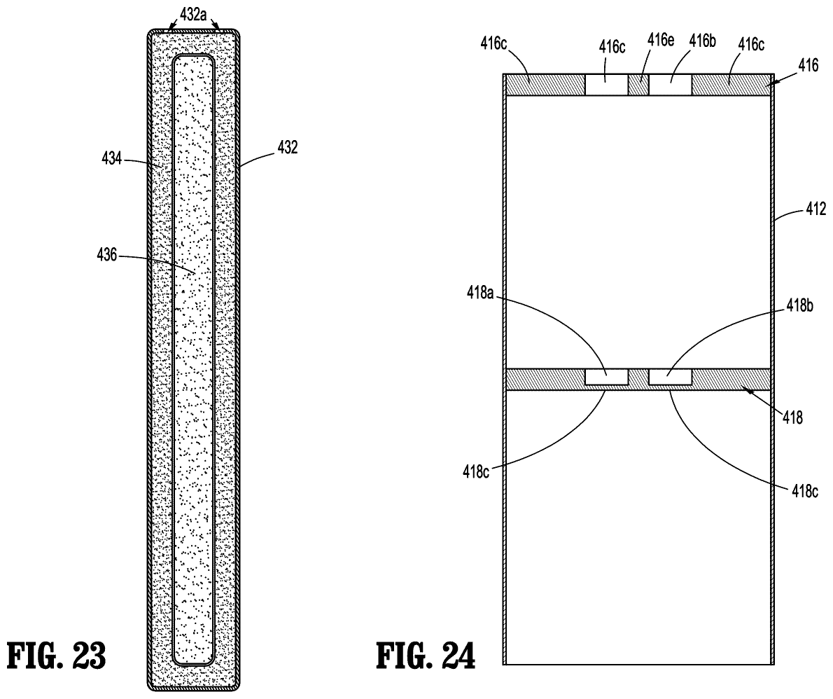

As best seen in FIG. 23, second tube member 430 of insect trapping apparatus 400 includes a flexible outer tube 432 including, for example, any suitable polymeric material, supporting a first material 434 therein, such as calcium carbonate, metal carbonate compounds, etc., or combinations thereof, and a second material 436, such as a weak acid solution, aqueous, and/or gel disposed within a vial (e.g., a glass vial) within first material 434. Flexible outer tube 432 defines apertures 432a in an upper end portion thereof.

In use, first and second tube members 420, 430 are flexed to induce chemical reaction in the respective first and second tube members 420, 430. In particular, flexing of first tube member 420 causes first tube member 420 to “glow”, as detailed above, and flexing of second tube member 430 causes carbon dioxide and attractant to dissipate from the second tube member 430 (e.g., via apertures 432a). And with the cover 414 removed from tubular member 412 and first and second tube members 420, 430 secured within tubular member 412 by upper and lower mounting assemblies 416, 418, insect trapping apparatus 400 will trap insects “I” on clear adhesive 412c on the outer surface of tubular member 412. The “glow” or light from first tube member 420 intensifies UV light as it reacts with the optical brightener (e.g., UV brightener) on tubular member 412, which coupled with the carbon dioxide and attractant, help to draw insects “I” to insect trapping apparatus 400. Insect trapping apparatus 400 can be hung by upper mounting assembly 416, placed on a flat surface, and/or include a hook member (not specifically shown; e.g., hook member 222) to facilitate hanging of insect trapping apparatus 400.

As can be appreciated, in aspects, any of the disclosed insect trapping apparatus can be disposed after use. Also, in aspects, any of the disclosed insect trapping apparatus, or components thereof, can be sealed in packaging (e.g., foil packaging, not shown) before use to help preserve the disclosed insect trapping apparatus and/or components thereof.

In aspects, the weak acids disposed herein may include gums, agar, acrylic and/or water-based gellants (with attractant).

Notably, a calcium carbonate and hydrochloric acid reaction is an exothermic reaction. When calcium carbonate reacts with hydrochloric acid, heat is released to the environment: CaCO3(s)+2HCl(aq)→CO2(g)+H2O(l)+CaCl2(aq).

Calcium Carbonate and Hydrochloric Acid Reaction|CaCO3+HCl

Calcium carbonate (CaCO3) is a metal carbonate compound and reacts with hydrochloric acid (HCl) to produce carbon dioxide (CO2), calcium chloride (CaCl2) and water. Carbon dioxide gas is released through the solution: CaCO3+HCl→CaCl2+CO2+H2O.

Carbon dioxide gas is released when a dilute acid is added to a metal carbonate. Metal carbonate compounds react with dilute acids and emit carbon dioxide gas. Here is a balanced chemical equation of CaCO3 and HCl reaction with physical states: CaCO3(s)+2HCl(aq)→CaCl2(aq)+CO2(g)+H2O(l).

Calcium carbonate is not soluble in water and exists as white precipitate in the water. When aqueous hydrochloric acid is added, calcium chloride, carbon dioxide and water are formed. Calcium chloride (CaCl2) is soluble in water and colorless. So, calcium chloride exists as an aqueous solution. Therefore, white precipitate is dissolved, and a colorless solution is formed with time. Also, due to formation of carbon dioxide gas, gas bubbles rise to the top of the solution. This reaction is used to calculate purity of CaCO3 samples when they are mixed with impurities. If impurity material does not react with dilute hydrochloric acid, one can conduct this experiment. Released carbon dioxide volume is measured and then the released amount (mol) of carbon dioxide gas can be calculated. Then, the reacted calcium carbonate amount and mass can be calculated.

Reaction properties: when calcium carbonate precipitate exists in water, that solution becomes weak due to a presence of carbonate ion. When aqueous HCl is added, carbonate is converted to carbon dioxide and alkalinity of the solution decreases. Calcium carbonate reacts with acetic acid to produce calcium acetate, water, and carbon dioxide. The most acidic fruits are lemons, limes, plums, grapes, grapefruit, and blueberries. Pineapples, oranges, peaches, and tomatoes are also high in acid.

The disclosed attractant, 1% Matsutake Alcohol (aka 1-octen-3-ol; Amyl Vinyl Carbinol) in 99% Propylene Glycol (PG), is named for the immensely popular Japanese Mushroom that is described as earthy, fungal, green, oily, and vegetative.

1-Octen-3-ol, octenol for short and also known as mushroom alcohol, is a chemical that attracts biting insects such as mosquitoes. It is contained in human breath and sweat, and it was once believed that insect repellent DEET worked by blocking the insects' octenol odorant receptors. Recent evidence in Anopheles gambiae and Culex quequinfasciatius mosquitoes suggest DEET reduces the volatility of 1-octen-3-ol which can result in a reduction in human attraction. 1-Octen-3-ol is a secondary alcohol derived from 1-octene. It exists in the form of two enantiomers, (R)-(−)-1-octen-3-ol and (S)-(+)-1-octen-3-ol. Octenol is produced by several plants and fungi, including edible mushrooms and lemon balm. Octenol is formed during oxidative breakdown of linoleic acid. It is also a wine fault, defined as a cork taint, occurring in wines made with bunch rot contaminated grape.

Synthesis: two lab syntheses of 1-octen-3-ol are by the Grignard reaction of acrolein and amyl iodide, and by the selective reduction of 1-octen-3-one. Biochemically, 1-octen-3-ol is generated from the peroxidation of linoleic acid, catalyzed by a lipoxygenase, followed by cleavage of the resulting hydroperoxide with the help of a hydroperoxide lyase. This reaction takes place in cheese and is used in biotechnology to produce the (R)-isomer.

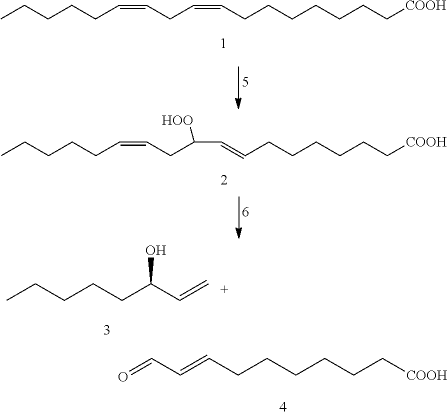

Biosynthesis of (R)-1-octen-3-ol: 1) linoleic acid, 2) (8E,12Z)-10-hydroperoxyoctadecadienoic acid, 3) (R)-1-octen-3-ol, 4) (8E)-10-oxodecenoic acid, 5) lipoxygenase, 6) hydroperoxide lyase.

In aspects, although any suitable colors may be utilized for the florescent dyes, a study found that when exposed to carbon dioxide, a gas humans constantly produce via exhalation, yellow fever mosquitoes (Aedes aegypti) developed heightened sensitivity to particular colors like red, orange, black, and cyan—predominantly long-wavelength visual cues.

Further, optical brighteners in accordance with aspects of this disclosure include optical brightening agents (OBAs), fluorescent brightening agents (FBAs), or fluorescent whitening agents (FWAs), and are chemical compounds that absorb light in the ultraviolet and violet region (usually 340-370 nm) of the electromagnetic spectrum, and re-emit light in the blue region (typically 420-470 nm) by fluorescence. These additives are often used to enhance the appearance of color of fabric and paper, causing a “whitening” effect; they make intrinsically yellow/orange materials look less so, by compensating the deficit in blue and purple light reflected by the material, with the blue and purple optical emission of the fluorophore.

Properties: the most common classes of compounds with this property are the stilbenes, e.g., 4,4′-diamino-2,2′-stilbenedisulfonic acid. Older, non-commercial fluorescent compounds include umbelliferone, which absorbs in the UV portion of the spectrum and re-emit it in the blue portion of the visible spectrum. A white surface treated with an optical brightener can emit more visible light than that which shines on it, making it appear brighter. The blue light emitted by the brightener compensates for the diminishing blue of the treated material and changes the hue away from yellow or brown and toward white.

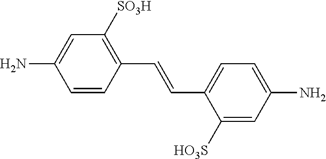 [SMILES: Nc1ccc(/C=C/c2ccc(N)cc2S(=O)(=O)O)c(S(=O)(=O)O)c1]

4,4′-diamino-2,2′-stilbenedisulfonic acid is a popular optical brightener.

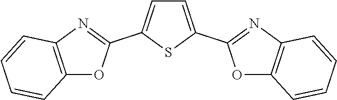 [SMILES: c1ccc2oc(-c3ccc(-c4nc5ccccc5o4)s3)nc2c1]

4,4′-bis(benzoxazolyl)-cis-stilbene and 2,5-bis(benzoxazol-2-yl)thiophene (shown here) are also intensely fluorescent and used as optical brighteners, e.g., in laundry detergents.[3]

Approximately 400 brightener types are listed in the international Colour Index database. The Colour Index Generic Names and Constitution Numbers can be assigned to a specific substance. However, some are duplicated since manufacturers apply for the index number when they produce it. The global OBA production for paper, textiles, and detergents is dominated by just a few di- and tetra-sulfonated triazole-stilbenes and a di-sulfonated stilbene-biphenyl derivatives. The stilbene derivatives are subject to fading upon prolonged exposure to UV, due to the formation of optically inactive cis-stilbenes. They are also degraded by oxygen in air, like most dye colorants. All brighteners have extended conjugation and/or aromaticity, allowing for electron movement. Some non-stilbene brighteners are used in more permanent applications such as whitening synthetic fiber.

Brighteners can be “boosted” by the addition of certain polyols, such as high molecular weight polyethylene glycol or polyvinyl alcohol. These additives increase the visible blue light emissions significantly. Brighteners can also be “quenched”. Excess brightener will often cause a greening effect as emissions start to show above the blue region in the visible spectrum.

In aspects, attractants of this disclosure can be included in the weak acid.

Persons skilled in the art will understand that the devices and methods specifically described herein and illustrated in the accompanying drawings are non-limiting exemplary aspects of the disclosure. It is envisioned that the elements and features illustrated or described in connection with one exemplary aspect of the disclosure may be combined with the elements and features of another without departing from the scope of the disclosure. As well, one skilled in the art will appreciate further features and advantages of the disclosure based on the above-described aspects of the disclosure. Accordingly, the disclosure is not to be limited by what has been particularly shown and described, except as indicated by the appended claims.

What is claimed is:

1. An insect trapping apparatus comprising:
a first surface coated with an adhesive and an attractant, the attractant including octenol;
a second surface supporting a first material, the first material including a calcium carbonate, a metal carbonate compound, or combinations thereof;
a third surface supporting a second material, the second material including a weak acid; and
at least one structure that is configured to be manipulated to cause the first and second materials to react with one another within the insect trapping apparatus and emit carbon dioxide from the insect trapping apparatus after the first and second materials react with one another.

2. The insect trapping apparatus of claim 1, wherein the first surface is an outer surface of a tube assembly.

3. The insect trapping apparatus of claim 2, wherein the outer surface includes a removable cover that is configured to peel-away from the outer surface.

4. The insect trapping apparatus of claim 3, wherein tube assembly defines a central cavity supporting a divider that separates the central cavity between an upper segment that supports the first material and a lower segment that supports the second material.

5. The insect trapping apparatus of claim 4, wherein the tube assembly defines a plurality of openings in the upper segment configured to enable the carbon dioxide to emit from the central cavity into ambient air surrounding the tube assembly.

6. The insect trapping apparatus of claim 4, wherein the at least one structure includes a rigid rod having a sharpened tip, the rigid rod coupled to the tube assembly and selectively movable relative to the tube assembly to cause the sharpened tip to pierce the divider and enable the first and second materials to react with one another.

7. The insect trapping apparatus of claim 4, wherein the rigid rod includes a detent structure configured to couple to the tube assembly to enable the sharpened tip to be suspended above the divider.

8. The insect trapping apparatus of claim 2, wherein the at least one structure includes a syringe assembly that is selectively receivable within the tube assembly, the syringe assembly including the second and third surfaces.

9. The insect trapping apparatus of claim 8, wherein the second surface is a divider that separates the first and second materials within the syringe assembly.

10. The insect trapping apparatus of claim 9, wherein the syringe assembly includes a plunger assembly having a sharpened tip configured to pierce the divider to enable the first and second materials to react with one another for causing carbon dioxide to release from the syringe assembly.

11. The insect trapping apparatus of claim 10, wherein the syringe assembly includes a support plate that secures the syringe assembly to a center ring supported within the tube assembly, the support plate defining a plurality of apertures to enable the carbon dioxide to release from an upper portion of the syringe assembly.

12. The insect trapping apparatus of claim 1, wherein the at least one structure includes a first elongated body member supporting the second surface and a second elongated body member supporting the second surface.

13. The insect trapping apparatus of claim 12, wherein the second surface includes first adhesive strips, and the third surface includes second adhesive strips, the first and second adhesive strips configured to secure to one another to secure the first and second elongated body members together.

14. The insect trapping apparatus of claim 12, wherein the first and second elongated body members are independent of one another.

15. The insect trapping apparatus of claim 12, wherein the first and second elongated body members are coupled together by a hinge that enables the first and second elongated body members to fold together to cause the first and second materials to react with one another for releasing carbon dioxide through slots defined between the first and second elongated body members.

16. The insect trapping apparatus of claim 2, further comprising a first tube member, and wherein the at least one structure includes a second tube member, the first and second tube members being selectively receivable within the tube assembly.

17. The insect trapping apparatus of claim 2, wherein the tube assembly includes a tubular member, the tubular member including the outer surface being formed of a material that is clear, and further comprising a first tube member, the first tube member being a glow stick that emits light through the clear material of the tubular member, and wherein the at least one structure includes a second tube member including the second and third surfaces, the second tube member supporting the first and second materials and being receivable with the first tube member in the tubular member, the second tube member being flexible to cause the first and second materials to react for emitting the carbon dioxide from the second tube member when the second tube member is disposed within the tubular member.

18. The insect trapping apparatus of claim 17, wherein the outer surface includes optical brighteners that intensifies the light from the glow stick to provide a visual attractant to insects while the octenol on the outer surface of the tubular member and the carbon dioxide emitted from the reaction of the first and second materials provide olfactory attractants to the insects, wherein each of the attractants are configured to lure and trap the insects on the adhesive on the outer surface of the tubular member.

19. An insect trapping apparatus, comprising:
a tube assembly having an outer surface supporting an adhesive including an octenol embedded therein; and
a tubular structure supporting a first material and a second material therein, the first and second materials being separated, wherein upon an application of sufficient force to the tubular structure, the first and second materials react with one another to emit carbon dioxide from the tubular structure, wherein the first material includes a calcium carbonate, a metal carbonate compound, or combinations thereof, and the second material includes a weak acid.

20. An insect trapping apparatus, comprising:
a first elongated body member having an inner surface supporting a first material and an outer surface supporting an adhesive and octenol, the first material including a calcium carbonate, a metal carbonate compound, or combinations thereof; and
a second elongated body member having an inner surface supporting a second material and an outer surface supporting an adhesive and octenol, the second material including a weak acid,
wherein the first and second elongated bodies include adhesive strips on the respective inner surfaces of the first and second elongated bodies, and
wherein the first and second materials are configured to react with one another to emit carbon dioxide from between the first and second elongated body members when the adhesive strips of the first and second elongated bodies are bonded together.
